(19) United States
(12) Patent Application Publication
(10) Pub. No.: US 2002/0116148 A1
(43) Pub. Date: Aug. 22, 2002

(54) Method for maintenance planning for technical devices

(76) Inventors: Joachim Bertsch, Baden-Dattwil (CH); Thomas Werner, Baden (CH)

Correspondence Address: Robert S. Swecker, BURNS, DOANE, SWECKER & MATHIS, L.L.P., P.O. Box 1404, Alexandria, VA, 22313-1404, US

(21) Appl. No.: 10/006,383

(22) Filed: Dec. 10, 2001

(30) Foreign Application Priority Data
Dec. 21, 2000 (EP) 00811221.1

(51) Int. Cl. G21C 17/00; G06F 15/00; G06F 11/30

(52) U.S. Cl. 702/184

(57) ABSTRACT

In a method and a system for maintenance planning for a technical device, a status value is in each case used to characterize a state of a technical unit. A state of a higher-level unit which has a number of subunits each having associated status values is characterized by a common status value, which is calculated as a weighted sum of the status values of the number of subunits. The common status value is used for planning maintenance tasks on the device.

In one preferred embodiment of the invention, a significance value is provided for the higher-level unit and is further-processed together with an associated common status value, preferably in a common visual display and/or a computer combination.

In a further preferred embodiment of the invention, any change in the status values with time is determined, and is used to predict a future development of status values.

### TECHNICAL FIELD

The invention relates to the field of maintenance planning for technical devices, in particular for electrical switchgear assemblies. It relates to a method, a system and a computer program product for maintenance planning for technical devices as claimed in the precharacterizing clauses of patent claims 1, 9 and 10.

### PRIOR ART

Such a method is known, for example, from U.S. Pat. No. 5,132,920. In this case, sensor data is detected, and malfunctions of components in a power station are diagnosed by means of an expert system. A severity level and a significance are in each case determined by means of the expert system for a malfunction, and malfunctions are organized on the basis of the priority of the required repair. The expert system has a rule base with a large number of logic rules of the “if symptom X appears and the value of the measurement variable Y is greater than 0.1, then there is a confidence of 0.8 that the hypothesis Z is correct” type. Other rules draw conclusions, for example, from the “hypothesis Z” and further information. The expert system furthermore has what is referred to an inference machine, which uses artificial intelligence methods to attempt to draw conclusions for servicing from the available measurement data on the basis of the rules.

The method thus requires a complex rule base and hence a large amount of manual effort for programming, and a large amount of computation effort in operation. Major effort is also required when the application of the method is extended, for example, from a part of a system to the entire system, since the links in the rules are closely related to the system structure. The system detects only malfunctions and hence does not detect any continuous deterioration in the equipment or system state.

### DESCRIPTION OF THE INVENTION

The object of the invention is therefore to provide a method, a system and a computer program product for maintenance planning for technical devices of the type mentioned initially, which are simple to program and to operate and, even when the device is operating without any faults, supply information about a state of the device with regard to maintenance planning, and which can be applied in a simple manner to a hierarchy of units in the device.

A further object of the invention is to provide a method, a system and a computer program product for maintenance planning for technical devices of the type mentioned initially which make it simple to produce a statement on the future development of a system state with regard to maintenance planning.

These objects are achieved by a method, a system and a computer program product for maintenance planning for technical devices having the features of patent claims 1, 9 and 10.

In the method and system according to the invention, a status value is in each case used to characterize a state of a technical unit, with a higher-level unit having a number of subunits each having associated status values and with a state of the higher-level unit being characterized by a common status value, which is calculated as a weighted sum of the status values of the number of subunits. The common status value is used for planning maintenance tasks on the device.

It is thus possible to combine status values with one another by means of a hierarchy of units, and to determine status values for higher-level units in a simple manner from status values for subunits. A corresponding computer program can be produced with little effort and does not require any major computation power, so that the method according to the invention can be executed on existing instrumentation and control computers without any additional hardware requirements.

In one preferred embodiment of the invention, each unit is allocated in each case one significance value, and at least one common status value is processed further in combination with or together with a respectively associated significance value, preferably in a common visual display and/or a computer combination.

In one preferred embodiment of the invention, any change in a status value within a predetermined time period is determined, and is used for planning maintenance tasks on the device. Units which are subject to severe loads can thus be determined and it is simple to produce a prediction of the future development of the status value.

Further preferred embodiments are described in the dependent patent claims.

### BRIEF DESCRIPTION OF THE DRAWINGS

The subject matter of the invention will be described in more detail in the following text with reference to preferred exemplary embodiments, which are illustrated in the attached drawings, in which:

FIG. 1 shows, schematically, an equipment structure and an information flow according to the invention;

FIG. 2 shows a visual representation of status and significance values according to the invention; and

FIGS. 3 and 4 show different limit curves to assess a state for technical units according to the invention.

The reference symbols used in the drawings, and their meanings, are listed in summarized form in the list of reference symbols. In principle, identical parts are provided with the same reference symbols in the figures.

### APPROACHES TO IMPLEMENTATION OF THE INVENTION

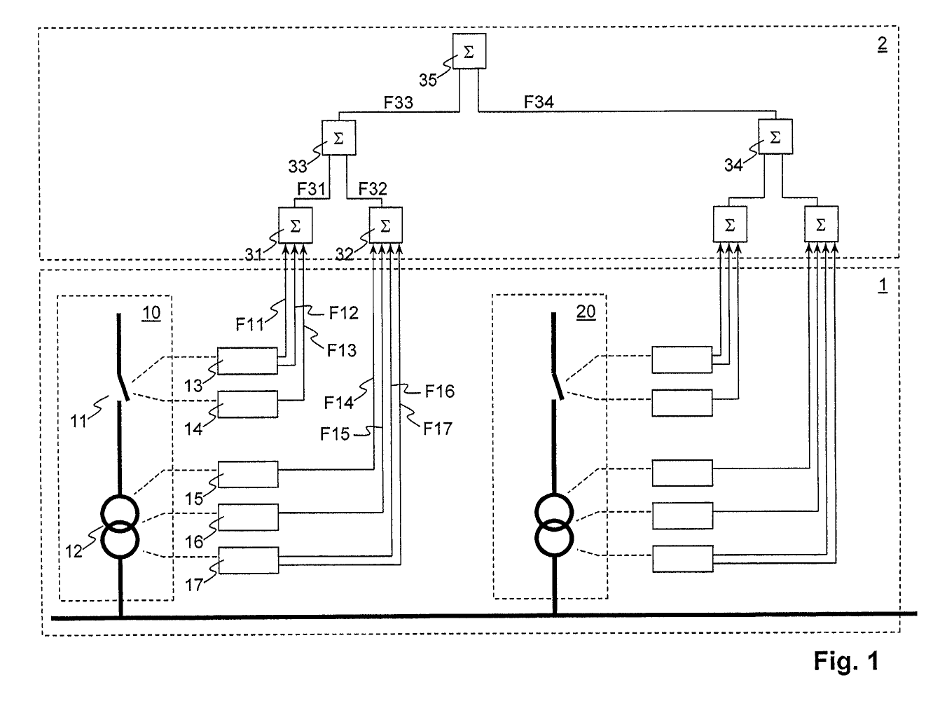

FIG. 1 shows, schematically, an equipment structure of a part of an electrical switchgear assembly, and an information flow according to the invention. The switchgear assembly has primary devices which carry out the actual system purpose, such as switches, drives, generators or transformers. These are controlled, regulated, monitored and protected by secondary or instrumentation and control appliances. A panel 1 of an electrical switchgear assembly has a number of outgoers 10, 20, which in turn have appliances such as a switch 11 and a transformer 12. Each appliance 11, 12 of a first outgoer 10 has at least one associated monitoring or control appliance, referred to in the following text as a panel unit 13 . . . 17. The panel units 13 . . . 17 are designed to transmit state values F11 . . . F18 to a first and a second summation unit 31, 32, which are in turn designed to transmit status values F31, F32 to a third summation unit 33. The third summation unit 33 and a fourth summation unit 34, which is associated analogously with a second outgoer 20, are designed to transmit status values F33, F34 to a fifth summation unit 35. The summation units 31, 32, 33, 34, 35 are preferably implemented on a control computer, or distributed over a number of control computers, in a station control system 2 for the switchgear assembly.

The invention functions as follows: the state values F11 . . . F18 each represent individual characteristics at any given time of the appliances for the first outgoer 10. The characteristics vary with time and depending on how the appliances are operated. The characteristics are measured repeatedly, or are calculated or estimated on the basis of measurements. This calculation or estimation is carried out in the panel units 13 . . . 17 or else, as an alternative to the illustration in FIG. 1, in the higher-level station control system 2. A panel unit 13 . . . 17 determines one or more respective state values F11 . . . F18. Each of the state values F11 . . . F18 is a real number, which is normalized to a predetermined value range. The value range is between a predetermined minimum value and maximum value, for example between 0 and 1 or between 0 and 100. During normal operation of the switchgear assembly, the state values F11 . . . F18 decrease with time. When a state value F11 . . . F18 reaches the maximum value, then this corresponds to an optimum state of that appliance with respect to this state. When a state value F11 . . . F18 reaches the minimum value, then the appliance requires maintenance for this state, irrespective of other states or characteristics.

State values F11 . . . F18 for appliances in a switchgear assembly represent, for example:

If transformer oil contains dissolved gas, this decreases the insulation characteristics of the oil. A so-called “dissolved gas analysis” value (DGA) denotes the amount of dissolved gas in ppm (parts per million). An increase by more than 16 ppm per month in the DGA during one day reduces a corresponding state value by 5% of the maximum value. An increase by more than 20 ppm per month in the DGA during one day reduces the state value by 10%.

If the cooling efficiency of a transformer is below 80% then a corresponding state value is reduced by 1% of the maximum value daily. This cooling therefore requires maintenance after at least 100 days. Since reduced cooling efficiency does not directly influence the operation of the transformer, the corresponding state value is given a relatively low weighting in the further processing.

If the transformer is operated on overload, then a corresponding state value is reduced depending on the magnitude and duration of the overload. Numerical determination of these relationships is governed by maintenance rules produced by the system operator.

Any given appliance has a state value which is reduced on the basis of the time period since the last servicing or inspection of the appliance, once again in accordance with predetermined maintenance rules.

Further state values characterize, for example, previous good or bad experiences with an appliance, or manually recorded information about an appliance.

According to the invention, a status value of the switch 11 or a first status value F31 is calculated in the first summation unit 31 as a weighted sum of the state values F11, F12, F13 which are allocated to the switch 11. This is done by allocating a weighting factor W11, W12, W13 to each of the state values F11, F12, F13. A weighting factor Wi determines how seriously any change in a status value Fi of a unit contributes to a change in the status value of the higher-level unit. For example, the status value F31 for the switch 11 is:

$$F31 = \frac{W11 \cdot F11 + W12 \cdot F12 + W13 \cdot F13}{W11 + W12 + W13}$$

In general, a common status value Fk of a higher-level unit which has n units with respective status values Fi={F1, F2, . . . Fn} and associated weighting factors Wi={W1, W2, . . . Wn} is:

$$F k = \frac{{\sum }_{i = 1}^{n} ( W i - F i )}{{\sum }_{i = 1}^{n} W i}$$

This means that the common status value Fk of the higher-level unit is equal to the sum of the status values Fi, weighted with the respective weighting factors Wi, of the subordinate units, divided by the sum of the weighting factors Wi. Division by the sum of the weighting factors Wi scales the value range of the status value, and is equivalent to the common value range of the state values. As an alternative to this, scaled weighting factors Wi′ are used, where

$$W {i}^{′} = \frac{W i}{{\sum }_{i = 1}^{n} W i}$$

$$so that$$

$$F k = {\sum }_{i = 1}^{n} ( W {i}^{′} \cdot F i ) .$$

The status value F31 of the switch 11 combines state information from various sources to form a single value. This value characterizes the state of the switch 11 as an entity, taking account of operational and maintenance rules produced by the system operator by means of the weighting factors Wi and by means of rules for determining the state values F11 . . . F18. That which applies to the individual states also applies to the switch 11, that is to say the status value F31 is equal to the maximum value in the optimum state, and decreases with time.

A second status value F32 of the transformer 12 is calculated in an analogous manner in the second summation unit 32 from corresponding state values F14 . . . F18 of the transformer 12.

Since status values are normalized to a common value range, status values for a number of different appliances can be compared and can also be combined to form status values for higher-level units, or joined together to form a common value. In the present example, this is done by combination, that is say by weighted summation, of the first status value F31 and the second status value F32 in the third summation unit 33. This results in a third status value F33 for the first outgoer 10. This is combined in a further hierarchy level with a fourth status value F34 for the second outgoer 20, and possibly with further status values for other parts of the switchgear assembly according to the invention to form a fifth status value F35 for the switchgear assembly. Status values for a number of switchgear assemblies can in turn be combined or joined together to form status values for a power distribution network.

The invention has the advantage that a common measure is established for assessment of a state of a technical unit in various hierarchy levels of a technical system or of a technical device 1. A technical unit is in this case an aspect or a component of an appliance 11, 12, or an appliance 11, 12 or an outgoer 10, 20, or a switchgear assembly 1 or an electrical high-voltage or medium-voltage network. A corresponding unit is itself identical to the entire device at the uppermost hierarchy level.

In general terms, the device comprises hierarchically subdivided units, with each unit being a subunit of a higher-level unit, and, with the exception of units which are at the lowermost hierarchy level, being a higher-level unit for a number of subunits.

In each hierarchy level, a common status value which is allocated to a higher-level unit is combined, according to the invention, from status values for a number of subunits. With regard to the appliances 11, 12 which it has, the first outgoer 10 is a higher-level unit, and with regard to the switchgear assembly 1 it is a subunit. Analogously to this, the third status value F33 is a common status value with regard to the first and second status values F31, F32, while being a status value for a subunit with regard to the fifth status value F35. The state values F11 . . . F18 are regarded as status values of subunits, with these subunits each corresponding to individual components and/or aspects of an appliance 11, 12. In the case of a transformer, for example, such aspects are: core temperature, oil temperature, DGA, time period and intensity of an overload, etc.

In one preferred embodiment of the invention, a number of status values Fi are indicated to a user and/or are used in an automated method for planning maintenance tasks on the switchgear assembly.

The invention can also be carried out on the basis of other computation rules, which are mathematically equivalent. For example, weighting factors Wi are defined for each specific state value for a specific appliance, and are then each multiplied by a common weighting factor for the appliance.

In one preferred embodiment of the invention, each unit is allocated in each case one significance value Ci, so that each unit has a significance value Ci. Since the unit is also allocated a status value Fi, the corresponding status and significance values Ci are also allocated. A significance value Ci indicates how important or how critical the unit is for the operation of the system or of the device. The significance value Ci is generally determined once and remains essentially unchanged unless the system configuration changes. Significance values Ci for different units are normalized to a common value range, for example to real numbers between 0 and 1. In this case, high values in the present example correspond to a high significance. The significance value Ci of an appliance is preferably a weighted sum of individual significance values Ci. Individual significance values Ci are determined, for example, on the basis of:

Costs to be expected in the event of failure of the appliance, for example resulting from production losses or delivery contracts with penalty payments for non-compliance.

Redundancy, which expresses whether it is possible to switch to a redundant appliance.

The time period required to change over.

Reliability of the changeover procedure.

Significance of the appliance in the system. For example, a main transformer in a power station has a considerably higher assessment than an outgoer switch for a residential area.

Depending on the policy and priorities of a company, different weightings of the significance values are chosen, for example in order to maximize operational reliability or to minimize maintenance costs.

In one preferred embodiment of the invention, a visual display is produced, which indicates a status value for the higher-level unit, together with the significance value, to a user.

A marking is preferably displayed in the visual display, with a first and a second coordinate direction, which marking is associated with a unit, and with a position of the marking in the first coordinate direction being determined on the basis of the status value Fi for that unit, and a position of the marking in the second coordinate direction being determined on the basis of the significance value Ci of that unit.

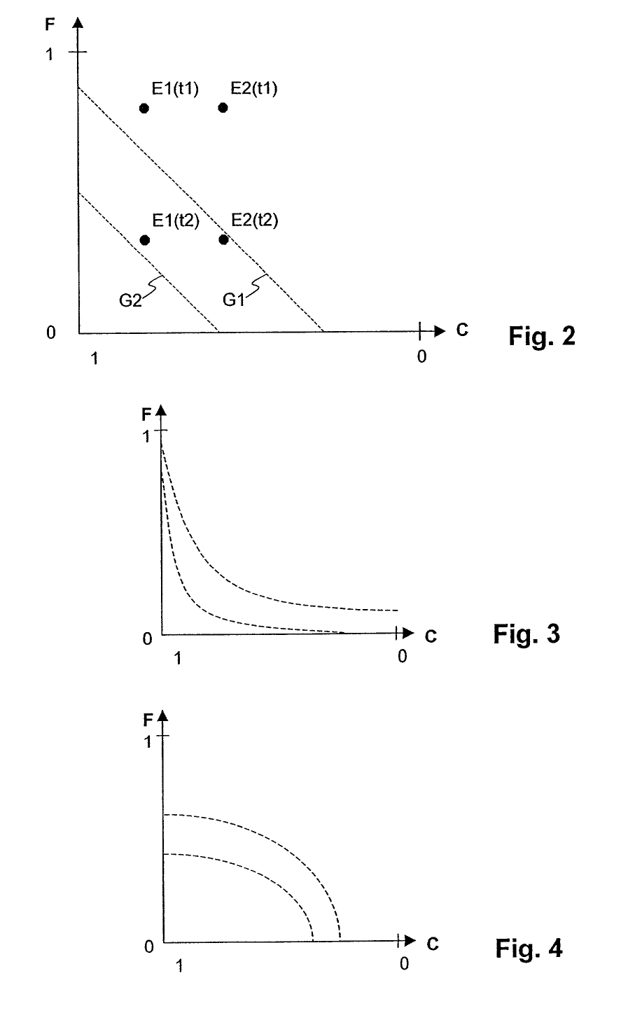

FIG. 2 shows an example of a visual display of status and significance values according to the invention. In this case, significance values Ci are plotted along a horizontal axis C, with a point with decreasing significance being shifted to the right. Status values Fi are plotted along a vertical axis F, with a point with a decreasing status value being shifted downward. Two points with markings E1(t1) and E2(t2) each describe a first and a second unit, for example two outgoers of a switchgear assembly, at a time t1. The status Fi of both units is assessed as being the same. However, the first unit has a higher significance Ci than the second unit.

The representation preferably has at least one limit curve, which curves subdivide the representation into a number of regions which correspond to different maintenance priorities; in the representation shown in FIG. 2, a first limit curve G1 indicates that servicing is recommended when a marking infringes this limit curve G1. A second limit curve G2 indicates that servicing is absolutely essential.

After a certain time, for example after a number of days, months or years, the points relating to the markings E1(t2) and E2(t2) have shifted. Depending on the position of the markings with respect to the limit curves G1, G2, it can be seen that servicing is recommended for both devices. The distance between each marking E1(t1), E2(t1), E1(t2), E2(t2) and a limit curve G1, G2 is preferably calculated in order to assess the urgency of servicing. The shorter this distance is, the greater is the urgency. Correspondingly, the urgency is greater for the first unit than for the second.

The representation according to the invention allows different types of technical units with different significance to be compared with one another, assisting overall maintenance planning.

In a further embodiment of the invention, the maintenance planning for a device or for a unit in the device is carried out on the basis of at least one associated status value Fi and one associated significance value Ci. In this case it is preferable to use a procedure analogous to the assessment process described above, based on the graphical representation, to carry out maintenance planning for a predetermined unit in the device on the basis of the distance between a point (E1(t1), E2(t1), E1(t2), E2(t2)) in a two-dimensional area from a limit curve G1, G2. In this case, a position of a point in a first dimension is determined by the status value Fi for the unit, and a position of the point in a second dimension is determined by the significance value Ci for that unit.

In a further embodiment of the invention, the limit curves are similar to hyperbolae, as shown in FIG. 3, or are similar to ellipses, as shown in FIG. 4.

A system according to the invention has means for determining a status value of a higher-level unit as a weighted sum of status values for the subunits of this higher-level unit, in which case the common status value can be used for planning maintenance tasks on that device.

A computer program product according to the invention for maintenance planning for technical devices has a machine-legible medium on which a program code is stored, which can be loaded into a computer and carries out the method according to the invention when executed on a computer.

In a further preferred embodiment of the invention, a differential status value dF is determined as the change in a status value Fi over a predetermined time period dT:

$$d F = ( \frac{{\sum }_{i = 1}^{n} ( W i \cdot F i )}{{\sum }_{i = 1}^{n} W i} ) \frac{1}{d T}$$

In this case, the time period dT is determined in accordance with the associated unit. For individual appliances such as switches or transformers, the time period dT is preferably approximately one month. For more complex units such as one or more switchgear assemblies, it is preferably approximately one year.

The differential status value dF is a measure of any loss of life of the associated unit. For example, a comparison of differential status value dF for a number of switches shows that one specific switch requires servicing, or ages, at a comparatively early stage. If this situation corresponds to a known severe load on the switch, it is, in some circumstances, accepted. However, if the operating conditions of the switch do not lead to the expectation of such aging, this indicates an unknown cause. The differential status value dF thus provides a diagnosis capability, which indicates unknown disturbance influences.

The differential status value dF can be used to produce a prediction of future development of the corresponding status value. This allows improved maintenance planning to be achieved. If, for example, two transformers have the same status value, but the differential status value dF of one transformer indicates more severe aging, then this transformer must be given priority for servicing. It may even be advantageous to service a first unit with a currently higher, that is to say better status, earlier than a second unit with a poorer status, if severe aging, that is to say a high differential status value dF for the first unit, leads to the expectation that its status value will become worse than that of the second unit over the next few months.

List of Reference Symbols

1 Switchgear assembly, substation

2 Station control system

10 First outgoer

20 Second outgoer

11 Switch

12 Transformer

13 . . . 17 Panel units

31 First summation unit

32 Second summation unit

33 Third summation unit

34 Fourth summation unit

35 Fifth summation unit

F11 . . . F18 State values

F31 First status value

F32 Second status value

F33 Third status value

F34 Fourth status value

F35 Fifth status value

Fi Status values

F Vertical axis, status value axis

C Horizontal axis, significance axis

Ci Significance values

Wi Weighting factors

G1 First limit curve

G2 Second limit curve

E1(t1), E2(t1), E1(t2), E2(t2) Markings

dT Time period

dF Differential status value

1. A method for maintenance planning for a technical device which comprises hierarchically subdivided units (1, 10, 11, 12, 20), with each unit being a subunit of a higher-level unit, and each unit, with the exception of units which are located on a bottom hierarchy level, being a higher-level unit for at least two subunits, and with a status value (Fi) being allocated to each of the units (1, 10, 11, 12, 20) in the method, which status value (Fi) characterizes a state of the unit, characterized
in that a state of a higher-level unit is characterized by a status value (Fi) which is calculated as the weighted sum of status values (Fi) for the at least two subunits of this higher-level unit, and
in that a number of status values (Fi) are used for planning maintenance tasks on the device.

2. The method as claimed in claim 1, characterized in that a number of status values (Fi) are indicated to a user, or are used in an automated method for planning maintenance tasks on the device.

3. The method as claimed in claim 1, characterized in that the status values (Fi) of the various units have a common value range, which is defined by a set of real numbers between a predetermined minimum value and a predetermined maximum value.

4. The method as claimed in claim 1, characterized in that each unit is allocated in each case one significance value (Ci), and in that a visual display is produced which, for at least one unit, indicates the associated status value (Fi) together with the associated significance value (Ci) to a user.

5. The method as claimed in claim 4, characterized in that a marking (E1(t1), E2(t1), E1(t2), E2(t2)), which is allocated to the unit, is displayed with a first and a second coordinate direction (F, C) in the visual display, with a position of the marking in the first coordinate direction (F) being determined on the basis of the status value (Fi) of the unit, and a position of the marking (E1(t1), E2(t1), E1(t2), E2(t2)) in the second coordinate direction (C) being determined on the basis of the significance value (Ci) of the unit.

6. The method as claimed in claim 1, characterized in that each unit is allocated in each case one significance value (Ci), and in that the maintenance planning for the device is carried out on the basis of status values (Fi) and significance values (Ci) which are each allocated to a number of units in the device.

7. The method as claimed in claim 6, characterized in that the maintenance planning for a predetermined unit in the device is carried out on the basis of the distance between a point (E1(t1), E2(t1), E1(t2), E2(t2)) in a two-dimensional space from a limit curve (G1, G2), a position of the point (E1(t1), E2(t1), E1(t2), E2(t2)) in a first dimension being governed by the status value (Fi) of the unit, and a position of the point (E1(t1), E2(t1), E1(t2), E2(t2)) in a second dimension being governed by the significance value (Ci) of the unit.

8. The method as claimed in claim 1, characterized in that any change (dF) in a status value (Fi) within a predetermined time period is determined, and is used to plan maintenance tasks on the device.

9. A system for maintenance planning for a technical device which comprises hierarchically subdivided units (1, 10, 11, 12, 20), with each unit being a subunit of a higher-level unit, and each unit, with the exception of units which are located on a bottom hierarchy level, being a higher-level unit for a number of subunits, and with the units (1, 10, 11, 12, 20) each having a status value (Fi) for characterizing a state of a unit, characterized
in that the system has means for determining a status value (Fi) of a higher-level unit as a weighted sum of status values (Fi) of the number of subunits of this higher-level unit, and
in that a number of status values (Fi) can be used for planning maintenance tasks on the device.

10. A computer program product for maintenance planning for technical devices, having a machine-legible medium on which a program code is stored, which can be loaded in a computer and carries out the method according to one of claims 1 to 8 when executed on a computer.
